(19) United States
(12) Patent Application Publication
(10) Pub. No.: US 2011/0224583 A1
(43) Pub. Date: Sep. 15, 2011

(54) Rehabilitation Device

(76) Inventor: Bruno Lequeux, Louvain-La-Neuve (BE)

(21) Appl. No.: 13/129,337

(22) PCT Filed: Nov. 10, 2009
(86) PCT No.: PCT/BE2009/000056

§ 371 Date: May 13, 2011

(30) Foreign Application Priority Data
Nov. 14, 2008 (BE) 2008/0623

(51) Int. Cl. A61H 1/02; A63B 24/00

(52) U.S. Cl. 601/5; 482/4

(57) ABSTRACT

The invention relates to a device (10, 80) for the physical rehabilitation and/or training of a person, that comprises a base (20, 90) and a mobile member (30, 100) capable of moving relative to the base (20, 90) according to one degree of freedom, guided by guiding means and slowed down by adjustable braking means, wherein the mobile member (30, 100) is provided with accessory attachment means (60, 70) for gripping or securing the limbs of said person. The device (10, 20) includes an assembly of position sensors (120) and pressure sensors (130) that can be secured on the mobile member (30, 100), on a gripping accessory (60, 70) secured on the mobile member and/or on the person, and a controller (110) capable of receiving signals transmitted by said position sensors (120) and pressure sensors (130) that enable the controller (110) to perform a biomechanical three-dimensional analysis, and to model and objectify the existing force momentum and the quality of the muscular exercise executed in order to provide movement rules and instructions to the person so that he/she can correctly execute a physical rehabilitation and/or training programme.

### TECHNICAL AREA

The invention relates to the field of devices used for rehabilitation and rehabilitation of patients, for training and strength training of athletes and prevention of physical and well-being of people.

### DESCRIPTION OF TECHNICS

It is recognized that the rehabilitation of patients, control parameters of movements made is essential. Among the modes of engagement, we distinguish the following modes: the isotonic mode, wherein the force provided by the muscle is common, the isometric mode, wherein the muscle provides a determined effort, and the member does not move, the isokinetic mode, in which the member moves to a predetermined speed, and provides a variable force. The practitioner wants to be able to select among these various modes, one that is best suited to its purpose.

It is known from WO0110508 a rehabilitation device comprising position sensors that can be attached to a patient's limb and adapted to transmit signals of position of one or more members to which are attached sensors and a controller capable of receiving and recording said signals and communicating to the patient instructions regarding the exercise to carry out. This device makes it possible to choose a program to perform movements by the patient and verify the correct execution of the movement program. However, this device is purely passive and only allows to measure positions and angles, and incidentally, the forces exerted by the patient's foot on the ground (examples 6 and 7). It does however not impose a move to a patient's limb, or apply a force on the member.

The applicant of the present invention has developed a device for proprioceptive rehabilitation and I or physical training, known as “Giroplan” and described in document EP0240497. The “Giroplan” consists of three interconnected elements: (1) A 360-degree rotative platform on which accessories can be fitted which allow to work all body parts. The tray has an adjustable brake, which adjusts the braking torque. (2) An electronic interface connected to the brake of the rotative platform that defines and controls the processing such as determining an amplitude of movement to go, adjustable resistance best suited to the needs of patients, speed of execution to achieve or not exceed, the time posture places beneficial for the patient, a determined number of amplitudes of insistence to carry out in each direction. (3) A database that stores data processing and allow to view its progress. This device has many advantages such as its simplicity, its lightness, which enables the therapist to use at the bedside and I or home visits, flexibility for a wide range of exercises and pathologies. This device includes an electromagnetic brake adjustable and controllable, and a measure of the angle of the rotative platform allows the user to perform a controlled manner any kind of exercise in which the resistance force and speed of execution can be variable amplitude programmed. However, it does not perform exercises in which force, movement or a combination are imposed by the apparatus of a mode: passive, active, isokinetic or isotonic (concentric or eccentric). It does not make possible to monitor the position and movement of a patient's limb in the three dimensions of space and impose a movement, while measuring the reaction force and to accurately view and model the operated target muscle by the patient, or to apply a force on the member, by measuring the resultant displacement and thus objectify in real-time the three-dimensional scope of rehabilitation initiated by the Giroplan.

There is therefore a need for a device that is simple, lightweight and portable, suitable for a large class of diseases and drives, and allows the patient to impose exercises in which force and/or movement (position, speed, acceleration) of a specific limb or limb segment of the patient being controlled by the unit.

### Resume of the Invention

The invention provides a device for rehabilitation and/or fitness of a person. The device includes a base and a moving member adapted to move relative to the base along a degree of freedom guided by guiding means. The mobile device is provided with means for attaching accessories gripping or fastening members of said person. According to the invention, the device includes a position and/or pressure sensor placed on the mobile device, accessories, or body of the user. The device includes a controller receiving position information and exerted pressure and able to conclude in real time the biomechanical of the movements performed by the user, to model the quality of muscular work and to give back movement instructions to the person in order to realize adequately the rehabilitation program and/or physical training. This provides a portable, easy and flexible to use device, that can be easily adapted to exploit that allows all records of functional rehabilitation: Neurology, Pediatrics, Geriatrics, Rheumatology, Traumatology, Orthopaedics, Traumatology, hemiplegia, physical preparation of athletes.

Preferably, servo motor means directly drive said movable and are able to impose user movements: passive or active, isometric, isokinetic or isotonic (concentric or eccentric). They advantageously comprise a servo-torque motor comprising a stator with a large number of poles and a rotor having permanent magnets, the rotor directly driving the mobile device. By “large number of poles” is meant in the context of the present invention, a number greater than 6, typically 32 or 64.

In a first embodiment of the invention, the movable platform is adapted to move along a degree of rotational freedom relative to the base. The servo-motor torque in this case is a rotary engine, and the guiding means are circular.

In a second embodiment of the invention, the mobile device is a carriage capable of moving along a degree of freedom of translation relative to the base. The servo-motor torque in this case is a linear motor, and guide means are also linear.

The controller is preferably connected to a display that indicates to the person the instructions to be conducted, the motion actually made and corrections. The instructions can also be transmitted as sound, for example, tones or a synthesis voice device.

The means for attaching accessories may include a plurality of dovetail grooves parallel in which accessories can be fixed. This gives a flexibility in choosing positions accessories.

Preferably, the set of position sensors include RFID tags to RFID, also known as the “RFID tags” (Radio Frequency Identification).

### BRIEF DESCRIPTION OF THE DRAWING

FIG. 1 is a perspective view of a first embodiment of a device of the invention in which the motion is rotative.

FIG. 2 is a perspective view of a second embodiment of a device of the invention in which the motion is linear.

FIG. 3 is a block diagram showing the components of a device of the invention, and their interactions.

FIGS. 4a and 4b are respectively a top view and bottom view of a device of the first embodiment of the invention.

FIGS. 5a, 5b and 5c are respectively a bottom view of a tray, on top of a base and side of a device of the first embodiment of the invention.

FIG. 6 is a below view of a device according to the second realization of the invention.

FIGS. 7a, 7b and 7c are respectively a bottom view of a carriage, above a base and side of a device of the second embodiment of the invention.

FIG. 8 is a front view and a rear view of a person on which are arranged position sensors of a device of the invention.

FIGS. 9a, 9b and 9c are respectively a view of the dorsal and palmar surface of hand and the plantar surface of one foot of a person on which are arranged position sensors and pressure sensors a device of the invention.

### DETAILED DESCRIPTION OF THE INVENTION

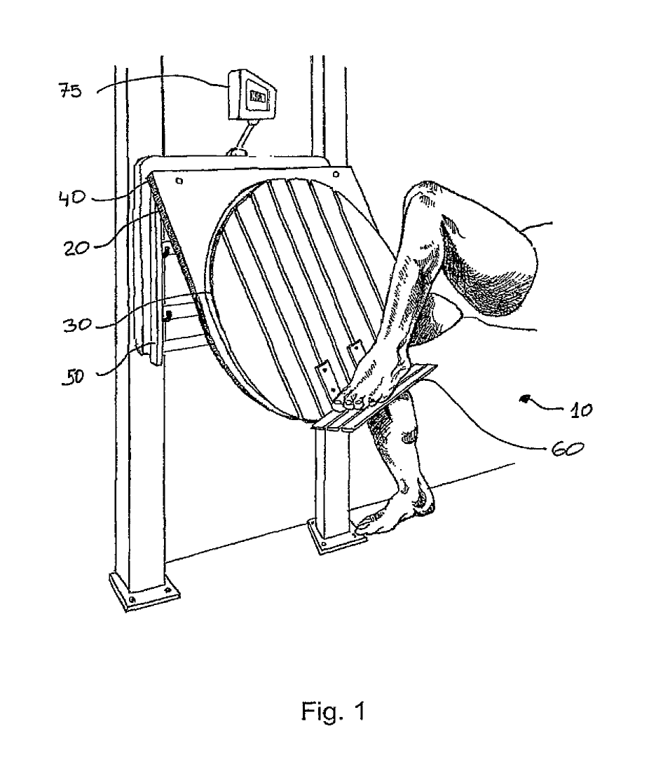

Referring to FIG. 1, a first embodiment according to the invention is described: the rotative rehabilitation apparatus 10. The arrangement of the base 20 of platform 30 and its accessories is in all respects similar to the “Giroplan” prior art cited above. The device 10 includes a base end 20 on which is mounted a rotating platform 30. The base 20 may be positioned at various angles being articulated by a hinge 40 to a base 50. The position of the base 20 is then maintained by means of a telescopic rod and fastening means. The platform 30 is mounted in rotation on the base 20. It is possible to mount on the platform 30 various accessories gripping or attachment of a member. FIG. 1 shows an example of a footrest 60 in which the patient's foot is held by a strap, which allows the person to apply a force of pressure or tension. It is advantageous to be able to fix these accessories in various parts of the base surface in order to adjust for example the radius of a rotational movement. As in the Giroplan, the base can be placed on the ground to allow the user among other things to work standing on the platform 30, but can also be mounted vertically on a stand, a wall, as shown in FIG. 1, or placed on a table. Unlike the “Giroplan” cited above, the apparatus of the invention comprises a servo motor torque (not shown in FIG. 1), a controller and a display 75, such as a screen that communicates instructions to the person. Also in addition to the possibility of placing the position sensors and I or pressure at different locations of the platform 30, it is possible to put, on some accessories and I or on the individual, position sensors and I or pressure of selected points. These sensors will be further described below.

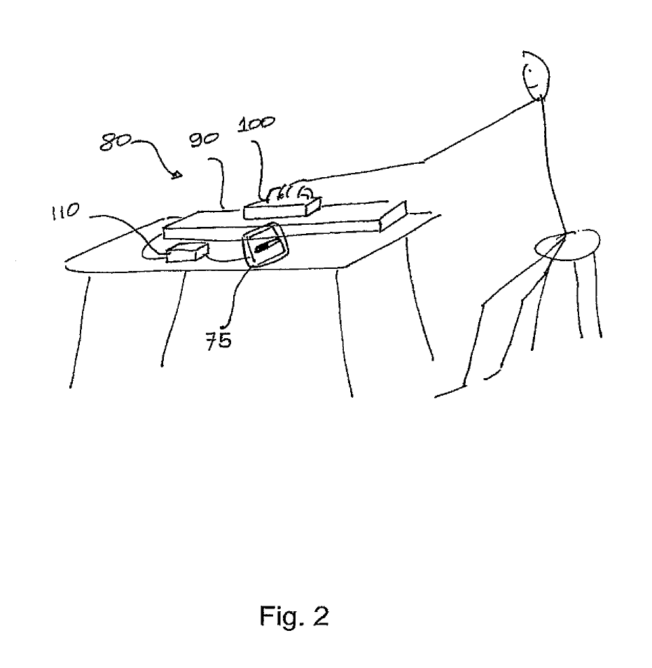

FIG. 2 is a perspective view of a second embodiment of a device of the invention in which the motion is linear. This device also includes a base 90. A carriage 100 can move in translation on such a distance of 1 m. A linear servo motor, described in more detail below, controls the movement of the carriage. A controller 110 controls the device and displays instructions on the display device 75.

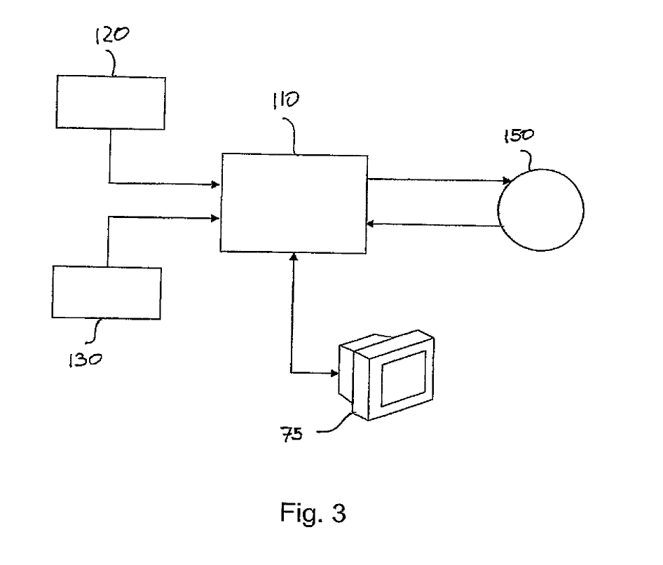

FIG. 3 is a block diagram showing the components of a device of the invention, and their interactions. The controller 110 receives signals from position sensors 120 and/or pressure sensors 130. Following the exercise program that has been selected, the controller 110 transmits the rotary servo motor 150 or linear servo motor 140 instructions angular position instructions, torque or angular velocity in the rotary embodiment, or position, force or speed in the linear embodiment. The Engine, 140, 150 can also transmit indications of angular position or torque or linear position or force.

The controller 110 also transmits to a display 75 of the instructions to the patient about the exercise to be performed (total number of repetitions/left) and intensity of exercise. In an isokinetic exercise, the patient is instructed to perform a movement with a predetermined speed. A bar graph on the screen shows the patient the actual speed achieved.
In addition, a mode of representation, such as color, indicates whether the achieved speed is lower than a desired range, or within that range. The controller 110 gives simultaneously instructions to the motor 150, 140 to adjust the resistance to be overcome by the muscle. The device of the invention therefore provides a visual or auditory feedback permanent. The position sensors. 120 can be “tagged RFID (Radio Frequency Identification). The acquisition of heading tags is performed with a period of about a millisecond, in the three dimensions of space, from a player placed on the base of the device or the user. We may also use transmitters gyroscopes. The position sensors 120 allow to know the position of the device 10, 80 relative to the attachment wall and its inclination and position of incidental thereto, and finally to determine with precision the different positions of body segments affected by the exercise performed.

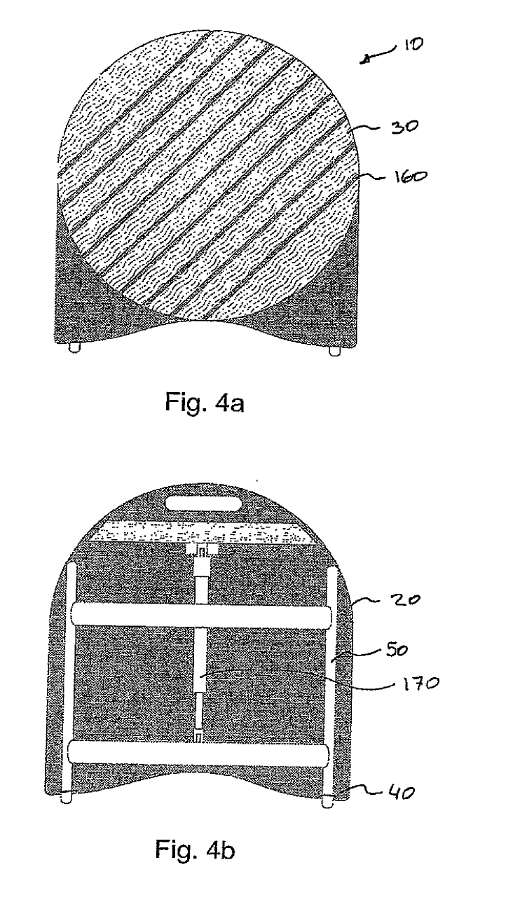

FIG. 4a is a top view of the rotary rehabilitation apparatus 10. The platform 30 includes a plurality of grooves section dovetail 160. We can fix one or more accessories in selected positions on the surface of the platform 30. We can adapt the device to the desired range of motion and size of the patient. FIG. 4b is a bottom view of the same device. The base 50 is hinged to base 20 by hinges 40. A telescopic rod or rods 170 can adjust the angle of inclination of the base 20 relative to the base 50. We can vary the type of movement to achieve and obtain the trajectories in three dimensions of space.

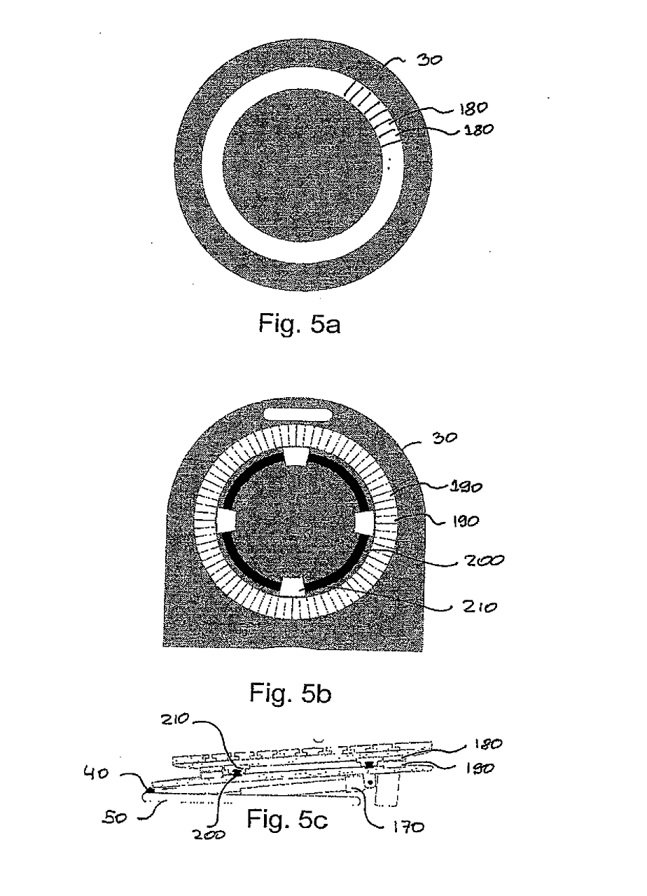

FIG. 5a is a bottom view of a platform 30 of the rotary rehabilitation apparatus. Permanent magnets 180 are aligned in a ring on the periphery of the platformau. These magnets 180 are arranged to produce a magnetic field perpendicular to the plane of the platform, and point alternately upwards and downwards from this plane. FIG. 5b is a top view of a pedestal. Windings 190 are arranged in a ring and face the permanent magnets 180. Inside the windings 190 is disposed with a slide rail 200 and movable parts 210. This slide provides that a predetermined distance is maintained between the permanent magnets 180 and coils 190 and allows rotation of the rotative platform 30. FIG. 5c is a side of device 10. The type of engine and slide has achieved a very compact device.

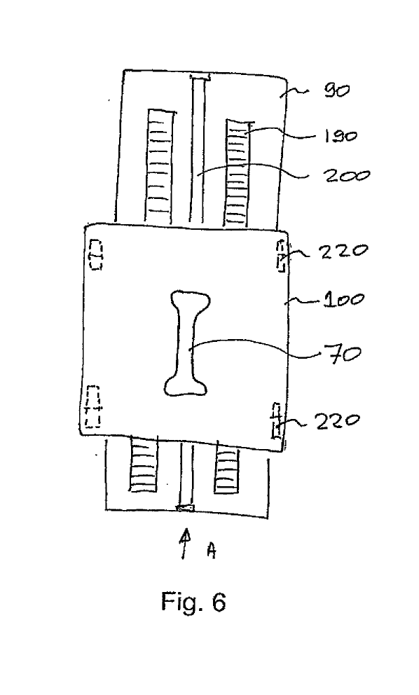

FIG. 6 is a bottom view of a device 80 in the second embodiment of the invention. On a pedestal 90 are mounted the coils of a linear motor 190 and rail 200 of a slide. A carriage 100 is secured to one or more movable elements 210 on the sliding rail 200. When the carriage 100 is large, you can mount the wheels 220 to guide its movement. A handle 70 is mounted on the carriage 100.

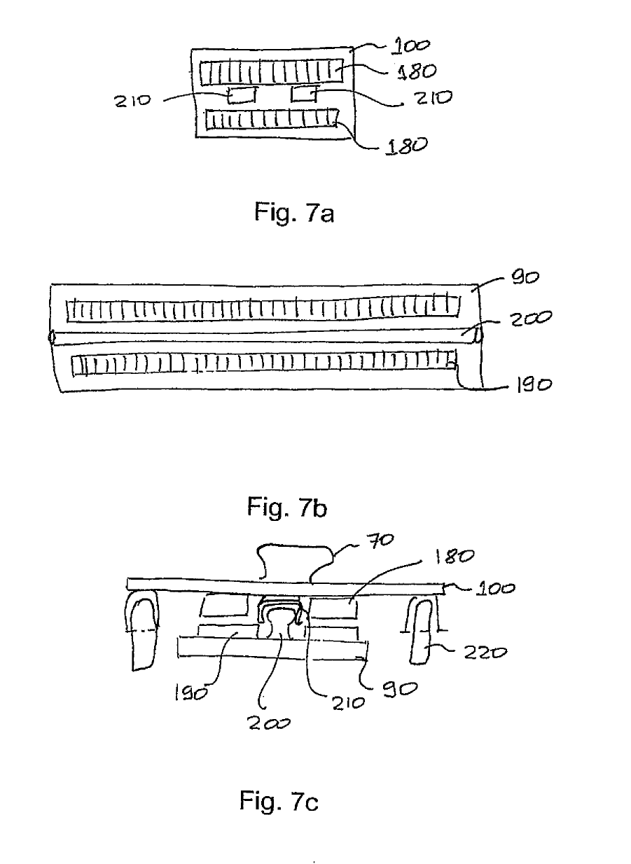

FIG. 7a is a bottom view of a carriage of a device according to the second embodiment of the invention, representing the permanent magnets 180 and mobile elements 210 of the movable slide attached to the carriage 100. FIG. 7b is a top view of a pedestal 90 of the slide rail 200 and 190 of linear motor windings. The 7C is a side view along arrow A in FIG. 6 of the same device.

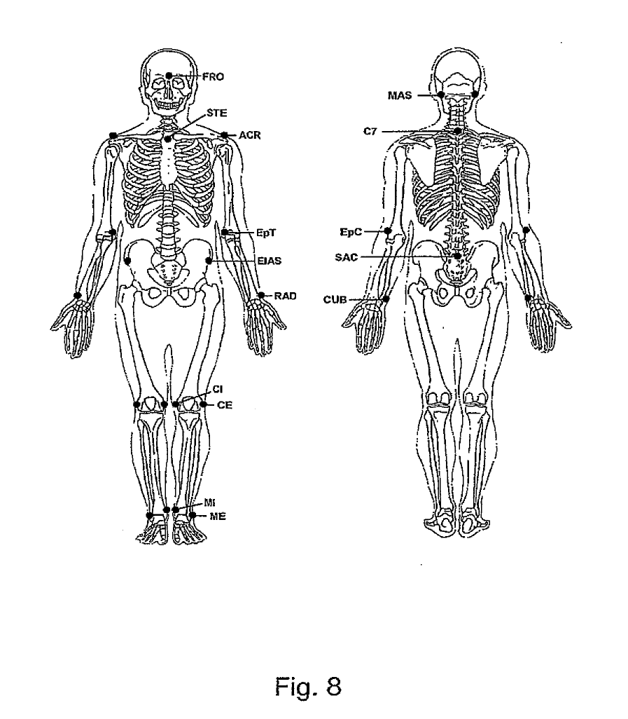

FIG. 8 is a front and back of a person on which are arranged position sensors of a device of the invention. Sensors are advantageously placed to selected positions, according to the needs of the exercises: external malleolus (ME), internal malleolus (MI), external condyle (EC), internal condyle (CI), anterior superior iliac spine (ASIS) Summit Sacrum (SAC) epicondyle (EPC), medial epicondyle (EFA), acromion (ACR) Sternum (ETS), 7th cervical (C7), mastoid apophyse (MAS), Front (NRF). Subsets of individual sensors can be formed to follow a limb or a segment of a particular member.

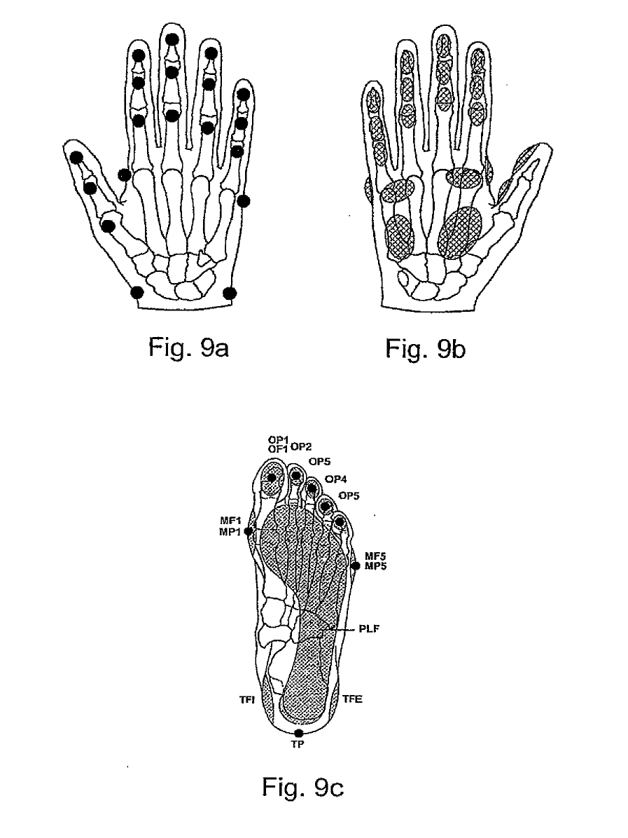

FIG. 9a a view of the dorsal surface on which position sensors were installed to the following: distal phalanges, outer surface of the distal end of the 1st, 2nd and 4th metacarpals, radial styloid process (thumb side), styloid process ulnar (little finger side). The FIG. 9B is a view of the palmar surface of hand on which pressure sensors were installed to the following: distal phalanx, distal end of the 2nd and 4th metacarpal, external surface of the distal end of the 2nd and 4th metacarpal bones, thenar (thumb side), hypothenar (little finger side). All position sensors and pressure of a hand can be advantageously placed in a glove. FIG. 9c is a view of the plantar surface of one foot of a person on which are arranged position sensors and pressure sensors to the following: (OF1 to OF5 and OP1-OP5) Toes 1 to 5 (sensors force and position), (MF1 and MF5) Outer surface of the distal end of the 1st and 5th metatarsal (PLF) force sensor plantar Face (TP) Talon position sensor, (TFI) force sensor inside of the heel (TFE) force sensor external surface of the heel. All these sensors can also be advantageously installed in a sock.

Both in the first embodiment, rotary, and in the other embodiment, linear, of the invention, preferably a servo motor torque, combined with a movable slide that keeps the distance between the stator and rotor engine . The torque motor has a stator with a large number of poles with reels. The rotor has permanent magnets. This avoids the need for a gearbox. The rotor directly drives the rotary table or carriage. In the rotary embodiment, the field is directed along the axis of rotation. No tree rotation is needed, the support being provided by the slide. In the embodiment linear, the field is perpendicular to the base. The slide may be a slide, ball provided by the company THK, and described in U.S. Pat. No. 5,265,963, or a slide friction.

The following examples show that for the same movement, the apparatus of the invention can induce completely different manner of executions through the servo-motor and/or sensors of the present invention.

### Example 1

### Strengthening the Classic Quadriceps Muscle

FIG. 1 represents an exercise of flexion/extension of the knee where the servo motor itself via the controller may require a different user mode: passive or active, isometric, isokinetic or isotonic (concentric or eccentric) but comprehensively as we use here only the stress sensors and position of the servo motor.

### Example 2

### Specific Strengthening of the Medial Great of the Quadriceps

As in FIG. 1, the person does a flexion/extension of the knee. A pressure sensor placed on the internal side of the fore foot allows to oblige the patient to push in a more or less important way on it while the flexion movement of flexion and extension to provoke the contraction more or less intense of the medial great of the quadriceps. According to the intensity of the exercised strain captor placed on the internal side of the fore foot (or from captor MF1 of FIG. 9c if we use the sock), according to the applied strain through the motor and to the position of the several position sensors placed on the inferior limbs and on the pelvis (FIG. 8 ME, MI, CE, CI, EIAS, SAC ; FIG. 9c MP1, MP5, TP position), it is possible to modelize in real time the moments of strain of the different segments involved of the inferior limb (tridimentional biomechanical data) and in particular the knee and so to determine at which intensity the medial great of quadriceps works.

### Example 3

### Neuromotor Control for a Hemiplegic Patient

For similar exercise two pressure sensors can be used, one placed below the forefoot and one under the heel (or from the sensor of PLF FIG. 9c if we use the sock), which allow :

1. to force the patient to distribute pressure evenly over the forefoot and heel.

2. to assist the patient to control this pressure distribution by increasing the resistance so defined if the execution speed slows and/or if the pressure decreases under the heel following neurological criteria defined in relation to the capacity of the patient.

Throughout the exercises, the device of the invention dialogue with the patient, displays the result and promotes constant effort, both in control of it as creating a beneficial rate by points of audio cues, visual or pressure sensation that endorse the right move. The device of the invention is not limited to mere “Muscle strengthening” but is also a new “platform for functional rehabilitation and physical preparation of athletes.” The device of the invention can collect as many therapeutic possibilities in a single system while objectifying their achievement. This device allows you to view and implement a controller via the distribution of moments of force of a three-dimensional movement induced performed by the device. Based on biomechanics and biometrics in particular it allows to evaluate precisely and in real time the work of a muscle or muscle group targeted a joint.

The terms and descriptions used herein are provided for illustrative purposes only and are not limitations. The skilled artisan will recognize that many variations are possible within the spirit and scope of the invention as described in the following claims and their equivalents; therein, all terms must be understood in their sense of larger unless it is otherwise indicated.

1. Device 10, 80 rehabilitation and/or fitness of a person having a base (20, 90) and a movable platform (30, 100) capable of moving relative to the base (20, 90) following one degree of freedom, guided by guiding means and braked by braking means being adjustable, the movable member (30, 100) being provided with means for attaching accessories (60, 70) for gripping or holding membership the said person, wherein the device (10,20) includes a set of position sensors (120) and pressure (130) being attachable to the movable platform (30, 100), an accessory grip (60, 70) secured to the movable and/or on the person, and a controller (110) adapted to receive signals transmitted by said position sensors (120) and pressure sensor (130) to the controller (110) to allowing the controller (110) to a three-dimensional biomechanical analysis, modeling and objectify the moments of forces and the quality of muscular work performed in order to give instructions and directions of movement for the person to realize appropriately a rehabilitation program and/or physical training.

2. Device (10, 80) according to claim 1, characterized in that it further comprises driving means (140, 150) capable of imposing a movement to said movable platform (30, 100), comprising a servo motor with stator (190) with a large number of poles and a rotor having permanent magnets (180), said rotor directly driving said movable platform (30, 100).

3. Device (10) according to claim 1, characterized in that the mobile device is a platform (30) capable of moving along a degree of rotational freedom relative to the base (20).

4. Device (80) according to claim 1, characterized in that the mobile device is a carriage (100) capable of moving along a translational degree of freedom relative to the base (90).

5. Device (10, 20) according to claim 1, characterized in that the controller (110) is connected to a display (75) which indicates, to the individual, instructions to be conducted, the movements actually performed and correction.

6. Device (10, 20) according to claim 1, wherein said means for attaching accessories include a plurality of dovetail grooves (160) parallel in which accessories can be fixed.

7. Device (10, 20) according to claim 1, wherein said set of position sensors (120) includes RF1D tags for RF1D.

8. Device (10, 20) according to claim 7 wherein the set of position sensors(120) and/or pressure (130) can be divided into subsets.
